(19) United States
(12) Patent Application Publication
(10) Pub. No.: US 2010/0106841 A1
(43) Pub. Date: Apr. 29, 2010

(54) Handling Proxy Requests in a Computing System

(75) Inventor: Andrew Barnert, San Francisco, CA (US)

Correspondence Address: FISH & RICHARDSON P.C., P.O. Box 1022, MINNEAPOLIS, MN, 55440-1022, US

(73) Assignee: ADOBE SYSTEMS INCORPORATED, San Jose, CA (US)

(21) Appl. No.: 12/259,604

(22) Filed: Oct. 28, 2008

(51) Int. Cl. G06F 15/16

(52) U.S. Cl. 709/227

(57) ABSTRACT

Systems, methods, and computer-program products receive a communication request, identify the communication request as a proxy request, generate a fake SID for the communication request, and transmit the proxy request using the generated fake SID.

### FIELD

The present disclosure relates to systems, methods, and computer program products for handling proxy requests.

### BACKGROUND

Tunneling protocols are used to encapsulate data, such as payload data, within a different delivery protocol. Tunneling is often used to carry data over incompatible delivery networks, and/or to provide a secure communication path over an untrusted network. Many different tunneling protocols are known. For example, HTTP tunneling is often used to permit communication from behind firewalls, proxy servers, and with software applications that lack native support for communication in restricted connectivity conditions. Another type of HTTP tunneling is RTMPT (Real time Messaging Protocol Tunneled), which encapsulates RTMP in valid HTTP requests and by default communicates on port 80. While RTMPT requires slightly higher bandwidth due to the addition of HTTP headers, the protocol can be used successfully in environments where security measures would block RTMP.

One problem that arises in computing systems is the use of different protocols in systems having applications and/or hardware designed for only a limited number or type of protocols. As an example, different requests may be used by a device (for instance, by an application and a web browser that the application may be embedded in), such as proxy requests and tunneling data requests. However, two different protocols often cannot share the same port, which may be desirable to an application programmer. Additionally, because proxy requests, unlike tunneling requests, do not have session IDS or sequence numbers, they cannot be processed using code developed to handle tunneling.

### SUMMARY

This specification describes technologies relating to handling proxy requests in a computing system. Proxy requests are initially distinguished from tunneling requests, which can be accomplished by inspection of the Uniform Resource Identifier (URI). A fake session ID (SID) and sequence number is created for each proxy request, after which the requests are handled using a tunneling system.

In general, one aspect of the subject matter described in this specification can be embodied in a method including receiving a communication request, identifying the communication request as a proxy request, generating a fake SID for the communication request, and transmitting the proxy request using the generated fake SID.

According to a feature, transmitting the proxy request using the generated fake SID includes transmitting the proxy request on the same socket as a transmitted tunneling request. According to another feature, identifying the communication request as a proxy request includes examining the Uniform Resource Identifier (URI) of the communication request. According to yet another feature, the method includes storing the fake SID for the communication request in a session map. The method can include generating a sequence number for the communication request. Generating a sequence number for the communication request can include generating a sequence number for the communication request using an auto-incrementing counter. Generating a sequence number can also or alternatively include incrementing a counter, and using a value of the incremented counter to generate the sequence number.

According to another feature, the method can include examining the communication request to identify a tunneling command. The tunneling command can be selected from the group of tunneling commands consisting of a request to open a session, a request to close a session, a request to send over a session, and a request to idle a session. In still another feature, the method can include generating a sequence number of zero (0) when the tunneling command is a request to open a session. Generating a fake SID for the communication request can also include generating a fake SID by looking up the fake SID in a session map. According to yet another feature, transmitting the proxy request can include transmitting the proxy request to a destination address.

According to another aspect of the invention, there is disclosed a computer-implemented method that includes transmitting a communication request, the communication request including a proxy request, receiving a fake SID in response to the communication request, the fake SID generated by a tunneling service, and transmitting the proxy request on the tunneling service using the generated fake SID.

According to yet another aspect of the invention, there is disclosed a system. The system includes a computing device, and a tunneling service operable to interact with the computing device and operable to perform operations including receiving a communication request from the computing device, identifying the communication request as a proxy request, generating a fake SID for the communication request, and transmitting the proxy request using the generated fake SID.

Other embodiments of this aspect include corresponding systems, apparatus, and computer program products.

Particular implementations of the subject matter described in this specification can realize one or more of the following advantages. Code developed to handle tunneling responses can handle proxy responses. Additionally, multiple protocols can share the same port, such as HTTP and RTMP requests.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIG. 1 shows an example computing system for handling proxy requests.

FIG. 2 shows an example process for identifying and handling proxy requests in a computing system.

FIG. 3 shows an example process for handling a proxy request to open.

FIG. 4 shows an example process for handling a proxy request to close, send, or idle.

FIG. 5 shows an example process for handling other proxy requests.

Like reference numbers and designations in the various drawings indicate like elements.

### DETAILED DESCRIPTION

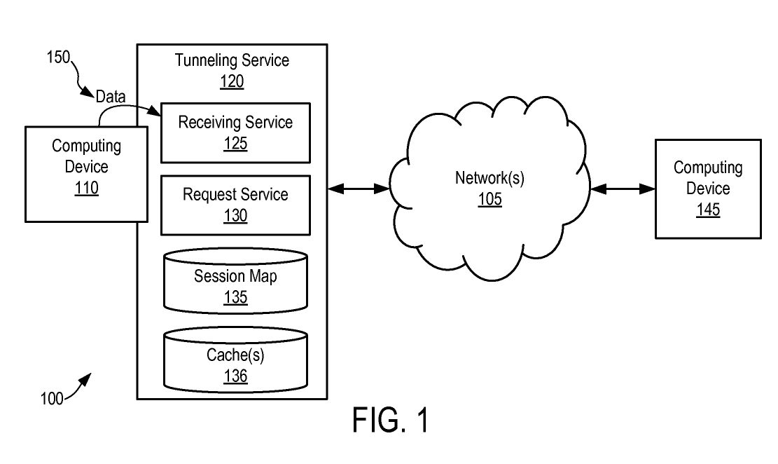

FIG. 1 shows an example computing system 100 for handling proxy requests. In particular, the system 100 permits the handling of proxy requests within a system configured to handle tunneling, such as RTMPT, such that tunneling code can handle proxy responses.

The system 100 generally includes a tunneling service 120 that can receive data 150 for transmission to a computing device 145. The data 150 may be communicated to the tunneling service 120 from one or more computers, such as computing device 110. According to some implementations, the tunneling service 120 can include, for instance, one or more servers or computers, such as a web server and/or a routing device, on a first network. It will be appreciated that the tunneling service 120 can represent an interface, such as a proxy server (including hardware and/or software) for instance, to a computing device that includes one or more applications supporting tunneling. Additionally, in some implementations, the tunneling service 120 can represent a tunneling application on the computing device 110.

After receiving data 150, the tunneling service 120 can transmit the data 150 to the computing device 145, such as a server or computer, on the same network as the tunneling service 120 or on another network. For instance, the tunneling service 120 may exist on a first local area network (LAN) and can transmit data included in a request to the computing device 145 on a second LAN. Although not illustrated in FIG. 1, the receiving computing device 145 can also include or may be in communication with a separate tunneling service. Additionally, in some implementations, the tunneling service 120 can operate on a single computing device. such as computing device 110, which may also be the same computing device as the receiving computing device, such as computing device 145.

The tunneling service 120 and computing device 145 can be connected through one or more networks 105. The network(s) 105 can include one or more public networks (e.g., the Internet or the public switched telephone network), one or more private networks (e.g., an enterprise network or a virtual private network), or a combination of both. Additionally, the network(s) can include wired or wireless channels, one or more internal computing system busses, one or more computer networks, or combinations thereof.

In some implementations, the system 100 can implement tunneling to effect the transfer of data from a first computing device to a second computing device, such as from computing device 110 to computing device 145. Thus, the data 150 received at the tunneling service can include a tunneling request, which can include control and connection requests such as “open”, “close”, “send”, “idle”, and the like, as are known in the art.

Generically, the process of tunneling encapsulates one protocol into another to provide for routable transport of otherwise unroutable packets. Tunneling processes create a transparent virtual network link between two network nodes, such as between the computing devices, that are unaffected by physical network links and devices. For example, the tunneling service 120 can create tunneling sessions to transmit data from the computing device 110 to the computing device 145 over the network(s) 105. Sessions, as are known in the art, are mechanisms through which connections between computing devices can be established and managed using tunneling requests.

According to some implementations, the system 100 can support RTMPT, which is tunneling of RTMP over HTTP. In particular, RTMP sessions can be tunneled over HTTP, where each session can be spread over multiple sockets, and each socket can handle multiple sessions. Sockets are bound to a port number so that the TCP layer can identify the application that data is destined to be sent to. To effect the transport of packets in sessions to one or more sockets, a session ID is included in the URI of each request after a session is opened. Because RTMPT, RTMP, and HTTP are well known they will not be described in further detail herein.

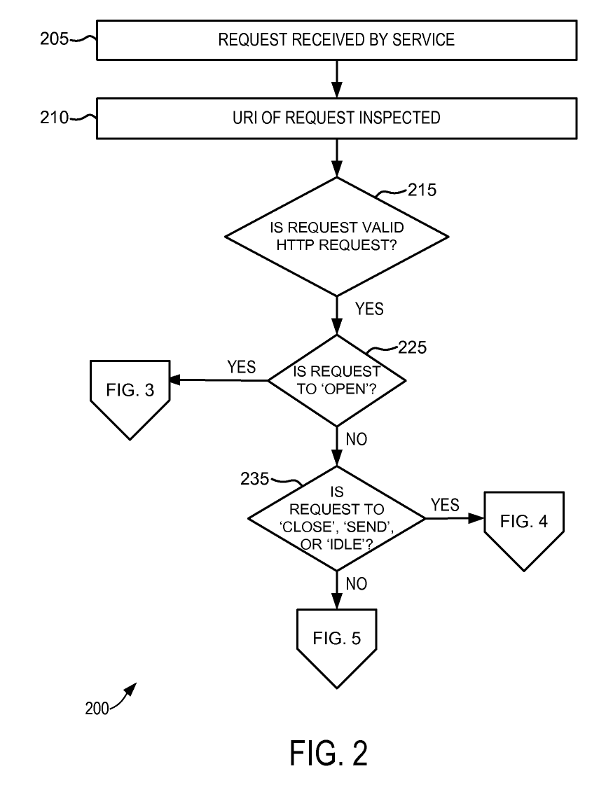

The system 100 shown in FIG. 1 can transport non-tunneling requests, including proxy requests, in a similar manner to tunneling requests. For instance, HTTP requests generated by the computing device 110 may be transported to the computing device 145 by the tunneling service 120. As explained in greater detail below with respect to FIGS. 2-5, the tunneling service 120 can generate fake SIDs and sequence numbers for non-tunneling, HTTP requests such that the system 100 can handle both tunneling and proxy requests, even on the same port.

In some implementations the tunneling service 120 includes a receiver 125, request service 130, a session map 135, and one or more caches 136 to effect the communication of non-tunneling requests in the system 100 of FIG. 1. Although illustrated as separate components within the tunneling service, the receiver 125, request service 130, session map 135, and/or caches 136 may be combined and/or further separable. Additionally, one of more of the receiver 125, request service 130, session map 135, and caches 136 may be external to the tunneling service 120 and in communication with the tunneling service 120 over one or more networks, such as the network(s) 105 shown in FIG.

The receiving service 125 receives a the data 150 (e.g., a tunneling request or an HTTP proxy request) from the computing device 110 and determines whether the request represents a proxy request (i.e., a non-tunneling request) or a tunneling request. If a non-tunneling request is identified, the request service 130 manages the tunneling of the proxy request to the computing device 145 using the session map 135, which stores sessions and the mapping of sessions to sockets. One or more caches 136, which can store responses to old requests, and/or the current sequence number for one or more sessions. The operation of the tunneling service 120 and system 100 will next be explained in greater detail with respect to FIGS. 2-5.

FIG. 2 shows an example process 200 for identifying and handling proxy requests in a computing system. Initially, a request is received 205, for instance, by the tunneling service 120. The request can represent, for instance, a tunneling request or a non-tunneling request, such as a proxy request (e.g., an HTTP proxy request). The URI of the received request is inspected 210. URIs, as are known, identify a resource on the Internet and can describe the mechanism used to access the resource (such as the http protocol), the computer that the resource is housed in and the name of the resource on the computer (the file name).

According to some implementations, the tunneling service 120 performs the inspection of the URI and identifies whether a request is a tunneling request or a non-tunneling request based on a section of the path namespace identified in the request. For instance, because a special section of the path namespace (e.g., /open/, /close/, /send/, /idle/, /fcs/, /fms/) can be reserved for tunneling, paths within the namespace are determined to be tunneling requests, and any path outside of this space is considered a proxy request. In some implementations the reservation of this namespace may be known by one or more applications on the computing device transmitting the request. Optionally, the request is examined to determine whether the request is a valid HTTP request 215. If not, the request cannot be processed, and a NULL value or the like may be transmitted as a response to the request.

If the request is a valid HTTP request, it is examined to identify what tunneling command (also referred to herein as tunneling function) is requested 215, 235. These functions can include, for instance, a request to “open”, “close”, “send”, or “idle”. Although the process 200 shown in FIG. 2 shows that the request is examined to identify whether the request is to “open”, followed by whether the request is to “close”, “send”, or “idle”, the order in which the functions are identified can be rearranged. In some implementations, the request is examined by the request service 130 of the tunneling service 120.

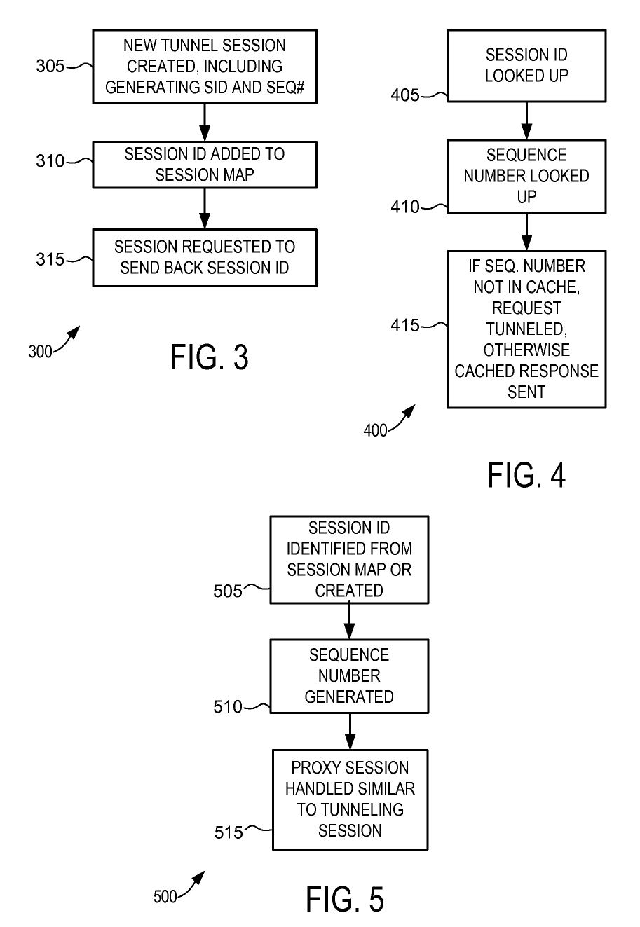

FIG. 3 shows an example process 300 for handling a proxy request to open a session. Upon receipt of the proxy request, a new tunnel session is created 305, for instance, by the tunneling service 120. As part of this process, a fake SID is generated, and the request is assigned a sequence number of zero (0) because no previous requests have been generated for the new session. According to some implementations, the request service 130 generates the fake SID and assigns the sequence number of zero.

In some implementations the generated fake SID is unique, such that no two sockets will get the same fake SID and no real tunneling session will collide with a fake SID. Additionally, each fake SID should be persistent. Because proxy requests (e.g., HTTP requests) do not include a SID or sequence number, in contrast with tunneling requests, a persistent SID permits the identification of the same session for each proxy request on the same socket, and the sequence numbers for those requests should continue to increment for a session. Additionally, unlike a tunneling session, a proxying session can't migrate from one socket to another (the SID is unique, determined by the socket), so an auto-incrementing counter is used during the session to establish the sequence numbers. The counter is tied to a session and can increase by one each time a new request is received by the tunneling service 120 for a session. According to some implementations, the auto-incrementing counter is executed by the request service 130, and the state of the counter and/or current sequence number is stored in the cache(s) 136.

After the fake SID is generated, the fake SID is added to the session map 310, which contains details of each session handled by the tunneling service 120. Thereafter, the session sends back the SID to the requesting client 315, such as the computing device 110.

Referring again to FIG. 2, if the request is not an “open” request 225, the tunneling service 120 can determine if the request is a “close”, “send”, or “idle” request. If so, the example process 400 shown in FIG. 4 is executed, for instance, by the tunneling service 120.

FIG. 4 shows an example process 400 for handling a close, send, or idle proxy request. When a proxy request is received for a previously generated session, the SID and sequence number are part of the proxy request, and are identified, for instance, by the request service 130. The request service responds to the request by looking up the SID 405, for instance, in the session map 135. The sequence number is also looked up, for instance, by the request service 130, to determine whether the request has already been handled, the previous result for the request is transmitted to the requester from an old request cache, such as one of the cache(s) 136. Thus, the response generated for each request may be stored by the tunneling service 120 in one or more caches. If the same request is sent again by the client (e.g., because the socket on which that request was originally sent is closed before the response is received), the cached response can be sent without having to repeat the request. For stateful protocols such as RTMP, this allows simpler state management. On the other hand, if the request has not been previously handled, the request is queued for tunneling behind any other requests for the same session having earlier sequence numbers.

If the request is not an ‘open’, ‘close’, ‘send’, or ‘idle’ request, the example process 500 shown in FIG. 5 for handling other proxy requests is executed, for instance, by the tunneling service 120. Upon receipt of the request, the request is given a fake SID 505. The fake SID session may looked up, for instance, from the session map 135 by the request service 130, and created and entered into the session map 135 if not found in the session map 135. The fake SID is unique to the socket and can be created from the socket handle using a hash, as is known in the art. A new sequence number is generated from an auto-incrementing counter in the session 510. According to some implementations, the auto-incrementing counter is executed by the request service 130, and the state of the counter and/or current sequence number is stored in the cache(s) 136. Thereafter, the proxy session is handled similar to a tunneling session 515.

Using the above methods, systems, and computer program products allows different communication protocols, such as HTTP and RTMP, to communicate on the same port. For instance, port 80, which is used for HTTP, may also be used for RTMP. In particular, proxied HTTP requests and RTMPT (RTMP tunneled over HTTP) can share the same port, and even the same socket. HTTP requests can be treated as tunneling requests by tying a session to each socket and generating a repeatable and unique session ID for each socket, and by using a simple counter attached to the session to generate unique sequence numbers.

Embodiments of the subject matter and the functional operations described in this specification can be implemented in digital electronic circuitry, or in computer application, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single application product or packaged into multiple application products.

Thus, particular embodiments of the invention have been described. Other embodiments are within the scope of the following claims. For example, the actions recited in the claims can be performed in a different order and still achieve desirable results.

1. A computer-implemented method comprising:
receiving a communication request;
identifying the communication request as a proxy request;
generating a fake SID for the communication request; and
transmitting the proxy request using the generated fake SID.

2. The method of claim 1, wherein transmitting the proxy request using the generated fake SID comprises transmitting the proxy request on a same socket as a transmitted tunneling request.

3. The method of claim 1, wherein identifying the communication request as a proxy request comprises:
examining the Uniform Resource Identifier (URI) of the communication request.

4. The method of claim 1, further comprising:
storing the fake SID for the communication request in a session map.

5. The method of claim 1, further comprising:
generating a sequence number for the communication request.

6. The method of claim 5, wherein generating a sequence number for the communication request comprises generating a sequence number for the communication request using an auto-incrementing counter.

7. The method of claim 5, wherein generating a sequence number further comprises incrementing a counter, and using a value of the incremented counter to generate the sequence number.

8. The method of claim 1, further comprising examining the communication request to identify a tunneling command.

9. The method of claim 8, wherein the tunneling command is selected from the group of tunneling commands consisting of a request to open a session, a request to close a session, a request to send over a session, and a request to idle a session.

10. The method of claim 9, further comprising generating a sequence number of zero (0) when the tunneling command is a request to open a session.

11. The method of claim 1, wherein generating a fake SID for the communication request comprises generating a fake SID by looking up the fake SID in a session map.

12. The method of claim 1, wherein transmitting the proxy request comprises transmitting the proxy request to a destination address.

13. A computer-implemented method comprising:
transmitting a communication request, the communication request comprising a proxy request;
receiving a fake SID in response to the communication request, the fake SID generated by a tunneling service;
transmitting the proxy request on the tunneling service using the generated fake SID.

14. The method of claim 13, wherein transmitting the communication request using the generated fake SID comprises transmitting the communication request on a same socket as a transmitted tunneling request.

15. The method of claim 13, further comprising generating a sequence number for the communication request.

16 The method of claim 13, wherein generating a sequence number for the communication request comprises generating a sequence number for the communication based on an auto-incrementing counter.

17 The method of claim 5, wherein the communication request comprises a tunneling command.

18. The method of claim 17, wherein the tunneling command is selected from the group of tunneling commands consisting of a request to open a session, a request to close a session, a request to send over a session, and a request to idle a session.

19. The method of claim 1, wherein transmitting the communication request comprises transmitting the communication request to a destination address.

20. A system, comprising:
a computing device; and
a tunneling service operable to interact with the computing device and operable to perform operations comprising:
receiving a communication request from the computing device;
identifying the communication request as a proxy request;
generating a fake SID for the communication request;
transmitting the proxy request using the generated fake SID.

21. The system of claim 20, wherein transmitting the proxy request using the generated fake SID comprises transmitting the proxy request on a same socket as a transmitted tunneling request.

22. The system of claim 20, wherein identifying the communication request as a proxy request comprises:
examining the Uniform Resource Identifier (URI) of the communication request.

23. The system of claim 20, wherein the tunneling service is further operable to perform operations comprising:
storing the fake SID for the communication request in a session map.

24. The system of claim 20, wherein the tunneling service is further operable to perform operations comprising:
generating a sequence number for the communication request.

25. The system of claim 24, wherein generating a sequence number for the communication request comprises generating a sequence number for the communication request using an auto-incrementing counter.

26. The system of claim 24, wherein generating a sequence number further comprises incrementing a counter, and using a value of the incremented counter to generate the sequence number.

27. The system of claim 20, wherein the tunneling service is further operable to perform operations comprising: examining the communication request to identify a tunneling command.

28. The system of claim 27, wherein the tunneling command is selected from the group of tunneling commands consisting of a request to open a session, a request to close a session, a request to send over a session, and a request to idle a session.

29. The system of claim 28, wherein the tunneling service is further operable to perform operations comprising generating a sequence number of zero (0) when the tunneling command is a request to open a session.

30. The system of claim 20, wherein generating a fake SID for the communication request comprises generating a fake SID by looking up the fake SID in a session map.

31. The system of claim 20, wherein transmitting the proxy request comprises transmitting the proxy request to a destination address.

32. A computer program product, encoded on a computer-readable medium, operable to cause a data processing apparatus to perform operations comprising:
receiving a communication request;
identifying the communication request as a proxy request;
generating a fake SID for the communication request; and
transmitting the proxy request using the generated fake SID.

33. The computer program product of claim 32, wherein transmitting the proxy request using the generated fake SID comprises transmitting the proxy request on a same socket as a transmitted tunneling request.
